(19) United States
(12) Patent Application Publication
(10) Pub. No.: US 2019/0391464 A1
(43) Pub. Date: Dec. 26, 2019

(54) SHUTTER DEVICE FOR A MOBILE DEVICE

(71) Applicant: Adam Mancuso, Royal Oak, MI (US)

(72) Inventor: Adam Mancuso, Royal Oak, MI (US)

(21) Appl. No.: 16/014,019

(22) Filed: Jun. 21, 2018

(51) Int. Cl. G03B 11/04

(52) U.S. Cl. CPC G03B 11/043

(57) ABSTRACT

A shuttering device for covering the lens portion for a mobile device. The shuttering device is sized to be fitted over the lens portion of the mobile device. The shuttering device is movable into a first position where it closes the lens portion to prevent taking of video or photos. The shuttering device also protects the lens portion of the mobile device. The shuttering device is movable into a second position where the lens portion is open and able to take videos or photos.

### BACKGROUND

### 1. Field

This application is directed to the field of mobile devices, in particular the application is related to shutter devices for lens portions of mobile devices.

### 2. Description of the Related Art

Many mobile devices have cameras. Frequently the lens for the camera is exposed. The constant exposure of the lens to the elements means that it can become dirty, scratched or otherwise damaged. Furthermore, the constant exposure of the lens means that video or photos may be taken anytime.

Therefore, there is a need in the field to provide a way in which mobile devices can have their lens covered.

### SUMMARY

Briefly described, aspects of the present disclosure relate to accessories for mobile devices, such as shutter devices for a lens portion of the mobile device.

An aspect of the present disclosure is an apparatus adapted for shuttering a lens portion of a mobile device. The apparatus has a perimeter, wherein the perimeter is adapted to engageably fit a lens portion of the mobile device, further wherein an opening is formed within the perimeter; a cover movably attached to the perimeter, wherein the cover is sized to move through the opening; wherein the cover is adapted to move to a first position where the lens portion is shuttered, and wherein the cover is adapted to move a second portion where the lens portion is open.

Another aspect of the disclosure is a mobile device. The mobile device has a mobile device housing; a lens portion; a shuttering device comprising; a perimeter, wherein the perimeter is adapted to engageably fit the lens portion of the mobile device, further wherein an opening is formed within the perimeter; a cover movably attached to the perimeter, wherein the cover is sized to move through the opening; wherein the cover is adapted to move to a first position where the lens portion is shuttered, and wherein the cover is adapted to move a second portion where the lens portion is open.

### BRIEF DESCRIPTION OF THE DRAWINGS

The foregoing and other objects, features, and advantages of the disclosure will be apparent from the following more particular description of embodiments as illustrated in the accompanying drawings, in which reference characters refer to the same parts throughout the various views. The drawings are not necessarily to scale, emphasis instead being placed upon illustrating principles of the disclosed embodiments.

FIG. 1 is a perspective view of an embodiment of a shuttering device.

FIG. 2 is another view of the shuttering device of FIG. 1 wherein the shuttering device is in an open position.

FIG. 3 is another view of the shuttering device of FIG. 1.

FIG. 4 is a perspective view of another embodiment of a shuttering device.

FIG. 5 is a view of the shuttering device of FIG. 4 in an open position.

### DETAILED DESCRIPTION

To facilitate an understanding of embodiments, principles, and features of the present disclosure, they are disclosed hereinafter with reference to implementation in illustrative embodiments. Embodiments of the present disclosure, however, are not limited to use in the described systems or methods and may be utilized in other systems and methods as will be understood by those skilled in the art familiar with this disclosure.

The components described hereinafter as making up the various embodiments are intended to be illustrative and not restrictive. Many suitable components that would perform the same or a similar function as the components described herein are intended to be embraced within the scope of embodiments of the present disclosure.

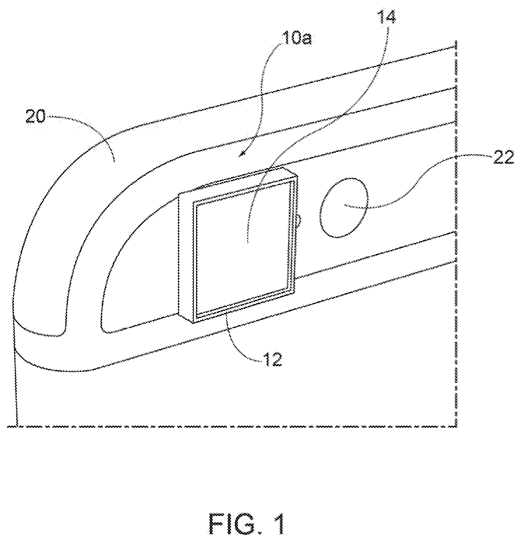

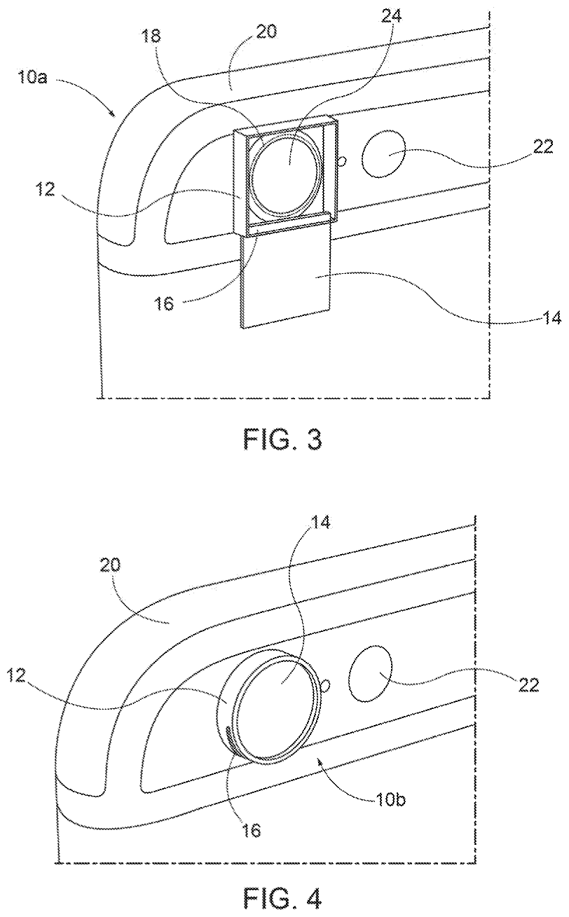

Now turning to the features of the present application, those features will now be discussed in detail with reference to FIGS. 1-3. FIGS. 1-3 show a mobile device 20 that has a shuttering device 10a. The mobile device 20 is a cell phone. In an embodiment, the mobile device 20 can be a tablet. In an embodiment, the mobile device 20 can be a laptop, or other computing device.

The mobile device 20 has a flash 22 and a lens portion 24. The lens portion 24 may be circular in shape. Other shapes may be possible for the lens portion 24. When other shapes are used for the lens portion 24 the shuttering device 10a may be altered accordingly so that the lens portion 24 may be properly shuttered.

The mobile device 20 is able to take video and photo via the lens portion 24. Access to the video features of the mobile device 20 can be made at anytime through the use of the mobile device 20.

In FIGS. 1-3, the shuttering device 10a is a square shaped apparatus. The shuttering device 10a comprises a perimeter 12, a cover 14, an opening 16 and a securing mechanism 18. The shuttering device 10a may be made of any acceptable material. In an embodiment the perimeter 12 and the cover 14 are made of plastic. In an embodiment, the perimeter 12 and the cover 14 are made of metal. In an embodiment, the perimeter 12 and the cover 14 are made of a ceramic or wood material. In an embodiment, the perimeter 12 and the cover 14 are made of the same material. In an embodiment, the perimeter 12 and the cover 14 are each made of separate materials. For example, the cover 12 can be made of plastic which the cover 14 is made of metal.

The perimeter 12 may be flexible so that it is able to move slightly when being fit around the lens portion 24. The perimeter 12 is able engageably fit the lens portion 24. In FIGS. 1-3 the perimeter 12 has four points of contact with the lens portion 24. The perimeter 12 is square shaped and engages the lens portion 24 at its top, sides and bottom. Since the perimeter 12 is square shaped there is a space created at the corners between the lens portion 24 and the perimeter 12. Additionally, the depth of the perimeter 12 is such that there is sufficient space formed above the lens portion 24 so that the cover 14 is able to move to the first position and the second position without being obstructed by the lens portion 24.

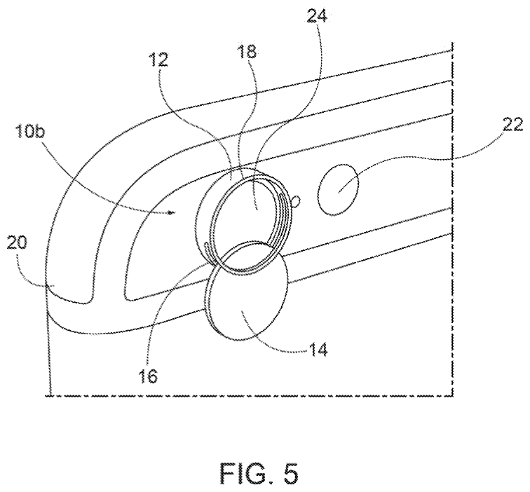

The perimeter 12 is shaped as a square so as to provide a secure fit around the circular lens portion 24. While the perimeter 12 is square shaped the perimeter 12 may have other geometric shapes. For example, the perimeter 12 may be triangular, pentagonal, hexagonal, octagonal. In the FIGS. 4 and 5, discussed below, the perimeter 12 is circular shaped. In an embodiment, the perimeter 12 may not extend completely around the lens portion 24. For example, the top portion of the perimeter 12 may not be present.

The perimeter 12 is sized so that it is able to be securely fitted around the lens portion 24. In an embodiment, additional measures can be taken to secure the engagement of the perimeter 12 to the lens portion 24. In an embodiment, the portions of the perimeter 12 that contact the lens portion 24 can be roughened so that there is additional frictional engagement with the sides of the lens portion 24. In an embodiment, the portions of the perimeter 12 that contact the lens portion 24 can have adhesive material located thereon.

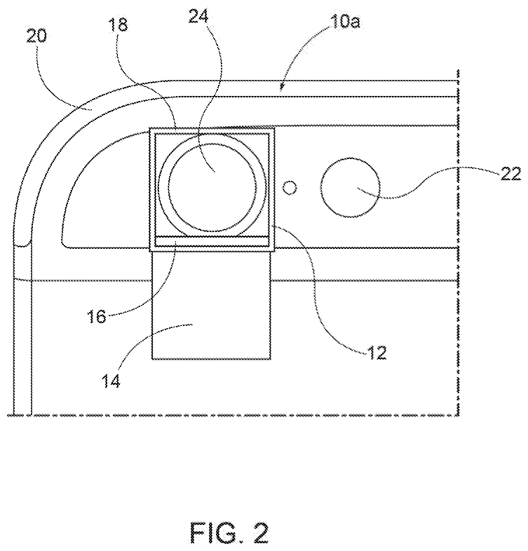

The shuttering device 10a also has a cover 14. The cover 14 is movably attached to the perimeter 12. The cover 14 moves through an opening 16 formed in the perimeter 12. The opening 16 is sized so as to permit the movement of the cover 14 from a first position, shown in FIG. 1 where the lens portion 24 is covered, to a second position, shown in FIG. 2 where the lens portion 24 is exposed.

When the cover 14 moves to the first portion the cover 14 engages the securing mechanism 18. In an embodiment, the securing mechanism 18 is a latching mechanism that is able to secure the cover 14. In an embodiment, the securing mechanism 18 is a magnetic surface that is able to magnetically engage the cover 14. The securing mechanism 18 can lock the cover 14 in its respective position. For example the securing mechanism 18 can lock the cover 14 in the first position. In an embodiment, the securing mechanism 18 can lock the cover 14 in the second position. In an embodiment, the securing mechanism 18 can lock the cover 14 in both the first position and the second position.

In an embodiment, the cover 14 is able to be activated and moved manually. In an embodiment, the cover 14 is able to be activated through the interface with the mobile device 20. For example, in the photo app, switching to the photo mode may send a signal, such as a Bluetooth enabled signal, to a receiver on the shuttering device 10a. The signal can trigger an activation mechanism that causes the cover 14 to move to the second position. In an embodiment, there is a button or switch located on the perimeter 12. When, the button or switch is activated, the cover 14 moves to the second position.

Turning to FIGS. 4 and 5, another embodiment is shown with a shuttering device 10b that is circular shaped. The perimeter 12 is sized to fit securely around the lens portion 24. The perimeter 12 has an opening 16 formed therein. The perimeter 12 may be sized to be slightly larger than the lens portion 14 so that it is able to engageably attached to the lens portion 14. The opening 16 formed in the shutter device 10b is formed so that it extends in an arc around the perimeter 12 of the shuttering device 10b. The opening 16 is preferably sized so that it is sufficiently spaced to permit the movement of the cover 14 from the first closed position, shown in FIG. 4, and the second closed position shown in FIG. 5. The opening 16 formed in the perimeter 12 is formed as an arc that is greater than 180 degrees. In an embodiment, the arc formed is greater than 240 degrees.

The cover 14 for the shuttering device 10b can be secured in the same manner as discussed above with respect to the shuttering device 10a. The cover 14 is able to move from the first position to the second position via a swivel or rotating motion. The cover 14 may be able rotate from the first position to the second position about a point located on the perimeter 12. In an embodiment, the cover 14 is able to move from the first position to the second position via a sliding motion. In an embodiment, the cover 14 is able to move form the first position to the second position via manual activation. In an embodiment, the cover 14 is able to be moved via activation through the interface of the mobile device 20.

The shuttering devices described herein are able to cover the lens portion of the mobile devices when needed. This can be whenever the camera is not needed or unwanted. Additionally, the shuttering device is able to protect the lens portion and prevent it from being damaged or becoming dirty. In an embodiment, when the cover is in the closed position there can be a notification displayed on the screen of the mobile device. This can let the user know that the lens portion is obstructed.

While embodiments of the present disclosure have been disclosed in exemplary forms, it will be apparent to those skilled in the art that many modifications, additions, and deletions can be made therein without departing from the spirit and scope of the invention and its equivalents, as set forth in the following claims.

What is claimed is:

1. An apparatus adapted for shuttering a lens portion of a mobile device comprising:
a perimeter, wherein the perimeter is adapted to engageably fit a lens portion of the mobile device, further wherein an opening is formed within the perimeter;
a cover movably attached to the perimeter, wherein the cover is sized to move through the opening;
wherein the cover is adapted to move to a first position where the lens portion is shuttered, and
wherein the cover is adapted to move a second portion where the lens portion is open.

2. The apparatus of claim 1, wherein the cover is adapted to be locked when in the first position.

3. The apparatus of claim 1, wherein the cover is magnetically secured in the first position.

4. The apparatus of claim 1, wherein the perimeter is square shaped.

5. The apparatus of claim 4, wherein the cover is square shaped and fits within the perimeter.

6. The apparatus of claim 1, wherein the perimeter is circular.

7. The apparatus of claim 6, wherein the perimeter is circular and adapted to fit within the perimeter.

8. The apparatus of claim 1, wherein the perimeter is square shaped and surrounds a circular lens portion.

9. The apparatus of claim 1, wherein the perimeter is circular shaped and surrounds a circular lens portion.

10. The apparatus of claim 1, wherein the cover is adapted to move between the first position and the second position via the actuation of a button on the mobile device.

11. A mobile device comprising:
mobile device housing;
a lens portion;
a shuttering device comprising;
a perimeter, wherein the perimeter is adapted to engageably fit the lens portion of the mobile device, further wherein an opening is formed within the perimeter;
a cover movably attached to the perimeter, wherein the cover is sized to move through the opening;
wherein the cover is adapted to move to a first position where the lens portion is shuttered, and
wherein the cover is adapted to move a second portion where the lens portion is open.

12. The mobile device of claim 11, wherein the cover is adapted to be locked when in the first position.

13. The mobile device of claim 11, wherein the cover is magnetically secured in the first position.

14. The mobile device of claim 11, wherein the perimeter is square shaped.

15. The mobile device of claim 14, wherein the cover is square shaped and fits within the perimeter.

16. The mobile device of claim 11, wherein the perimeter is circular.

17. The mobile device of claim 16, wherein the perimeter is circular and adapted to fit within the perimeter.

18. The mobile device of claim 11, wherein the perimeter is square shaped and surrounds a circular lens portion.

19. The mobile device of claim 11, wherein the perimeter is circular shaped and surrounds a circular lens portion.

20. The mobile device of claim 11, wherein the cover is adapted to move between the first position and the second position via the actuation of a button on the mobile device.
